(19) United States
(12) Patent Application Publication
(10) Pub. No.: US 2004/0031349 A1
(43) Pub. Date: Feb. 19, 2004

(54) Children's tricycle front strut structure

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/222,585

(22) Filed: Aug. 19, 2002

(51) Int. Cl. B62K 21/16

(52) U.S. Cl. 74/551.3

(57) ABSTRACT

A front strut structure for a children's tricycle comprises a front strut, a handle support, and a handle, wherein the front strut has a pair of hollow outer pipes with holes thereon, the handle support has a pair of insertion rods each with a reduced section having holes and a fastener. By inserting the insertion rods of the handle support into the outer pipes of the front strut to facilitate the installation, whereas the fasteners extend through the holes of the handle support and the front strut to secure the handle support and the front strut together.

### FIELD OF THE INVENTION

This invention relates to a front strut structure of a children's tricycle, and more particularly to the structure, which is easy to assemble and disassemble adequately and accurately.

### BACKGROUND OF THE INVENTION

There are numerous children's tricycles on the market, but these designs are all formed with the handle integral with the front strut, or uses fasteners to secure the two together. These designs either can not be disassemble or consume times to disassemble, in particular to the requirement of changing the handle, this has to consume more time both to the consumer and to the production line, that increases the cost.

In view of this, the inventor has devised the present invention, which makes improvements with respect to the above-mentioned shortcomings.

### SUMMARY OF THE INVENTION

It is the primary object of the present invention to provide a front strut structure for a children's tricycle, which provides a quick and accurate assembling front strut structure for a children's tricycle.

It is another object of the present invention to provide a front strut structure for a children's tricycle, which consumes less assembling time and saves production time to lower the cost of manufacture.

It is a further object of the present invention to provide a front strut structure for a children's tricycle, which is easy to assemble and disassemble of the front strut.

### BRIEF DESCRIPTION OF THE DRAWINGS

FIG. 1 is an exploded view of the present invention;

FIG. 2 is a perspective view of the present invention;

FIG. 3 is a side view of a tricycle incorporated with the present invention;

FIG. 4 is a side view of a tricycle incorporated with a second embodiment of the present invention;

FIG. 5 is an exploded view of a third embodiment of the present invention; and

FIG. 6 is a side view of a tricycle incorporated with the third embodiment of the present invention.

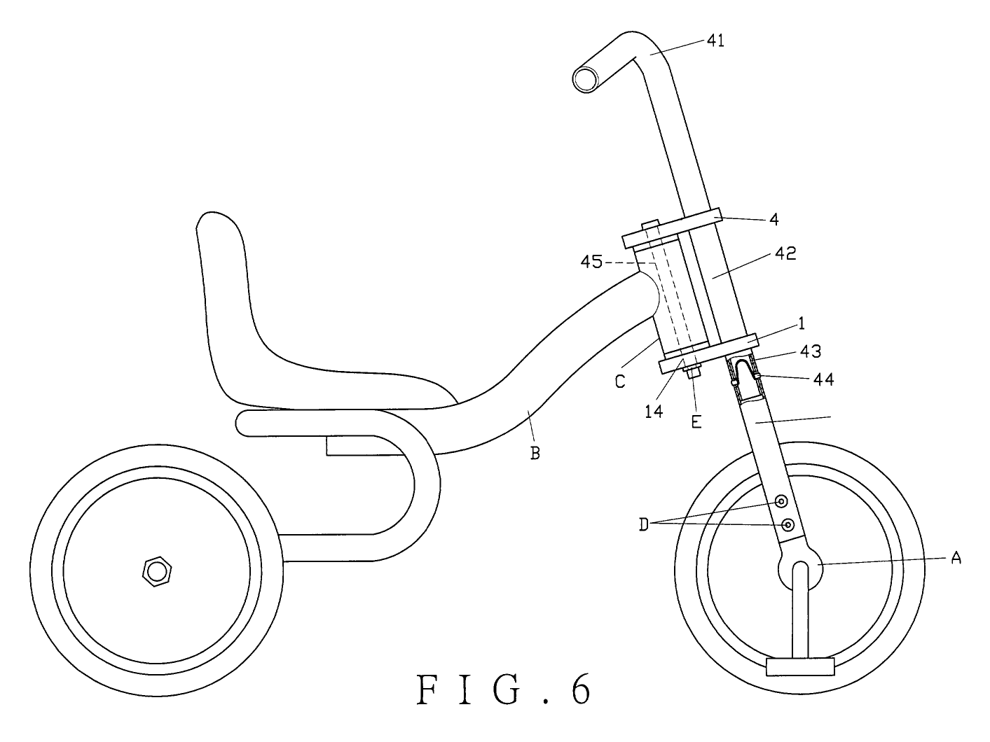

### DETAILED DESCRIPTION OF THE PREFERRED EMBODIMENTS

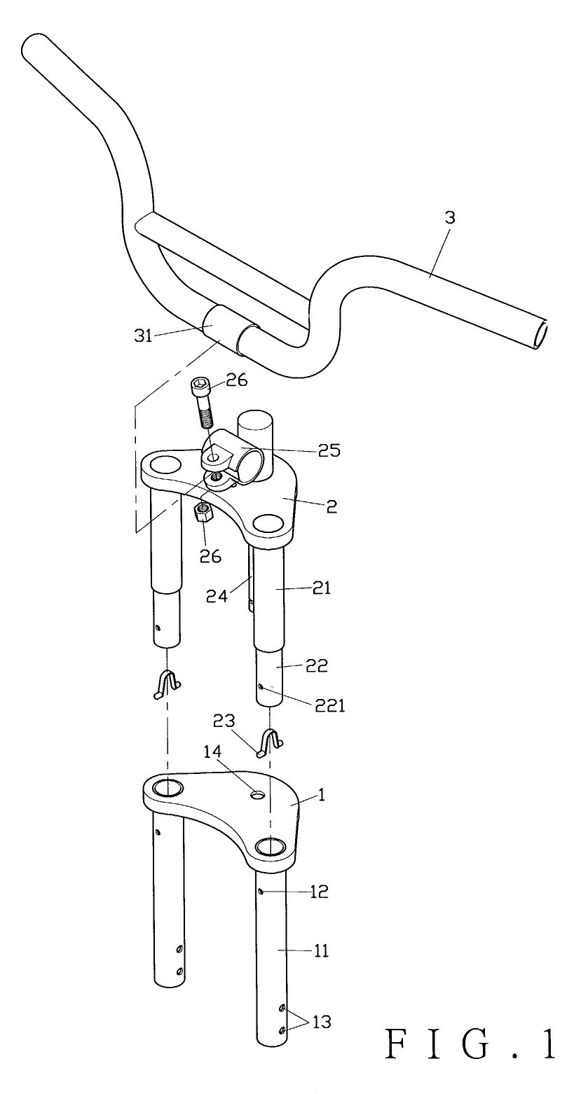

The front strut structure of the present invention, as shown in FIG. 1, is generally composed of a front strut 1, a handle support 2, and a handle 3.

The front strut 1 has a pair of hollow outer pipes 11 at the front portion and a pivoting hole 14 at the rear portion. Each of the outer pipes 11 has a pair of holes 12 on the upper portion and a plurality of locating holes 13 at the lower portion.

The handle support 2 comprises a pair of insertion rods 21 at the front, a pivoting rod 24 at the rear, and a C-shaped clip 25 on the top. Each of the insertion rods 21 has a reduced section 22 at the lower end. Each of the reduced sections 22 comprises a pair of holes 221 corresponding to the holes 12 of the outer pipe 11. Each of the reduced sections 22 comprises an elastic clip 23, which has its ends extending outwardly from the holes 221. The C-shaped clip 25 uses a fastener 26 to secure the handle 3 thereat.

The handle 3 comprises a center section 31 to be located in the C-shaped clip 25 for securing the handle 3 thereat.

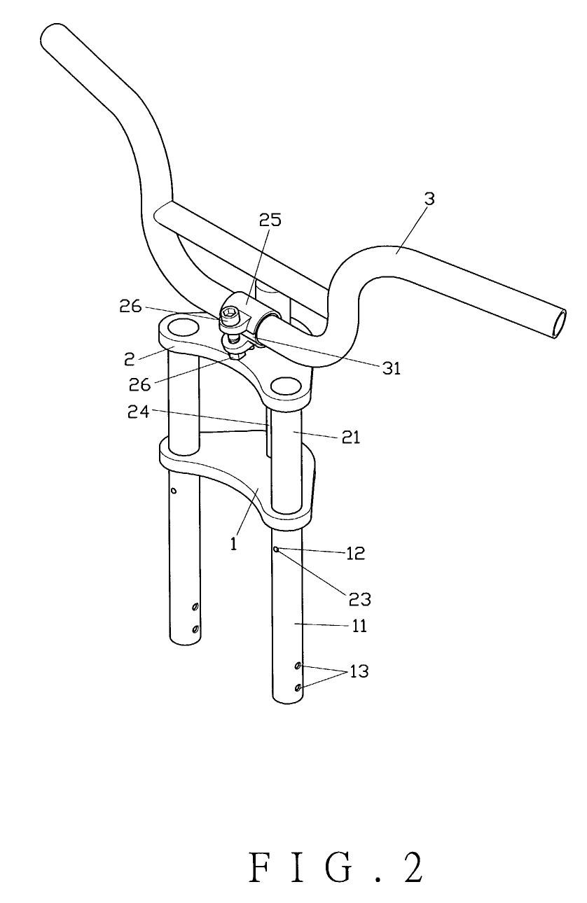

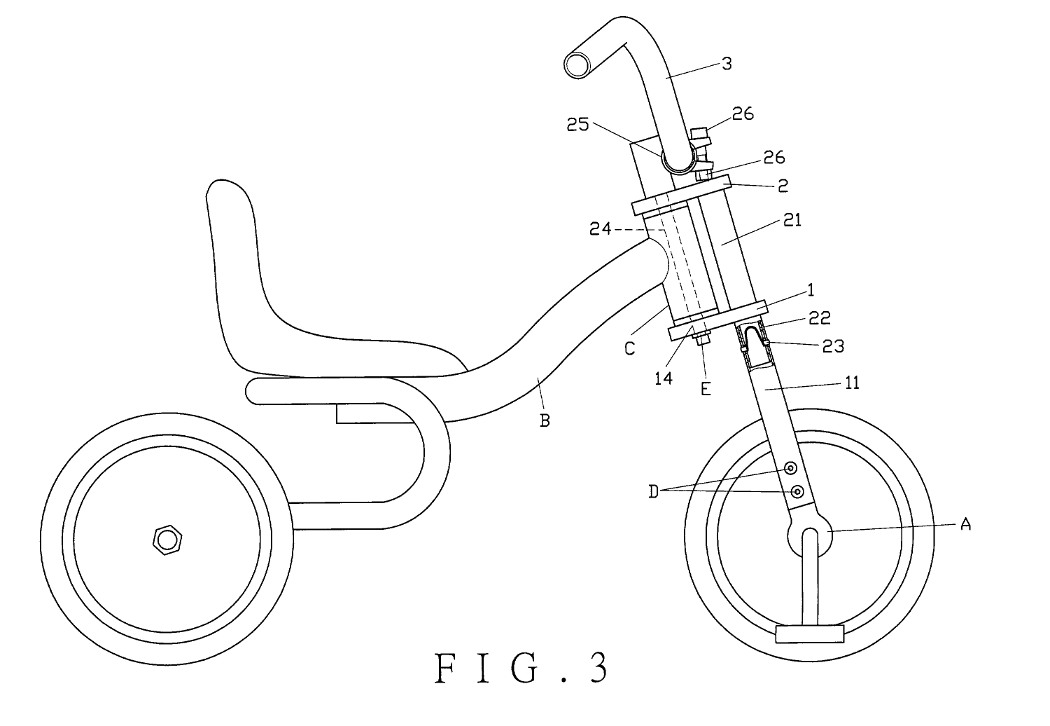

To assemble the present invention, as shown in FIGS. 2 and 3, the center portion 31 of the handle 3 is placed in the C-shaped clip 25 and fastened with the fastener 26. The front wheel A is secured between the two outer pipes 11 of the front strut 1 with fasteners D go through the locating holes 13 and the wheel A is secured thereat. The pivoting rod 24 of the handle support 2 is inserted through the pivoting hole 14 of the front strut 1 and into a connecting pipe C of a tricycle body B and secured with a fastener E. The two reduced sections 221 of the insertion rods 21 are inserted into the outer pipes 11 of the front strut 1 with the clips 23 extending outwardly from the holes 221 into the holes 12. This facilitates the installation in an adequate and accurate manner and completes the installation of the present invention.

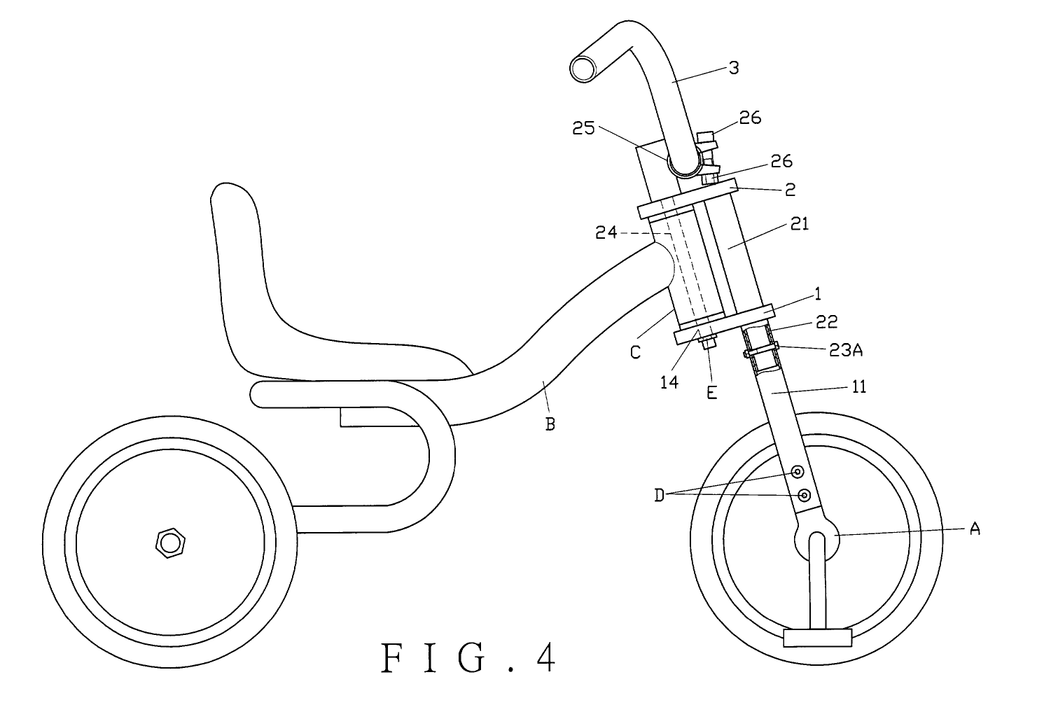

FIG. 4 shows a second embodiment of the present invention, which is replaced the clips 23 with bolts, screws, pins or rivets. To assemble the present invention, the reduced sections 22 of the insertion rods 21 of the handle support 2 are inserted into the outer pipes 11 of the front strut 1 with the holes 12 of the outer pipes 11 aligning with the holes 221 of the reduced sections 22, and then fasteners 23A are inserted into the holes 12 and 221 and secured thereat. This completes assembly of the second embodiment of the present invention.

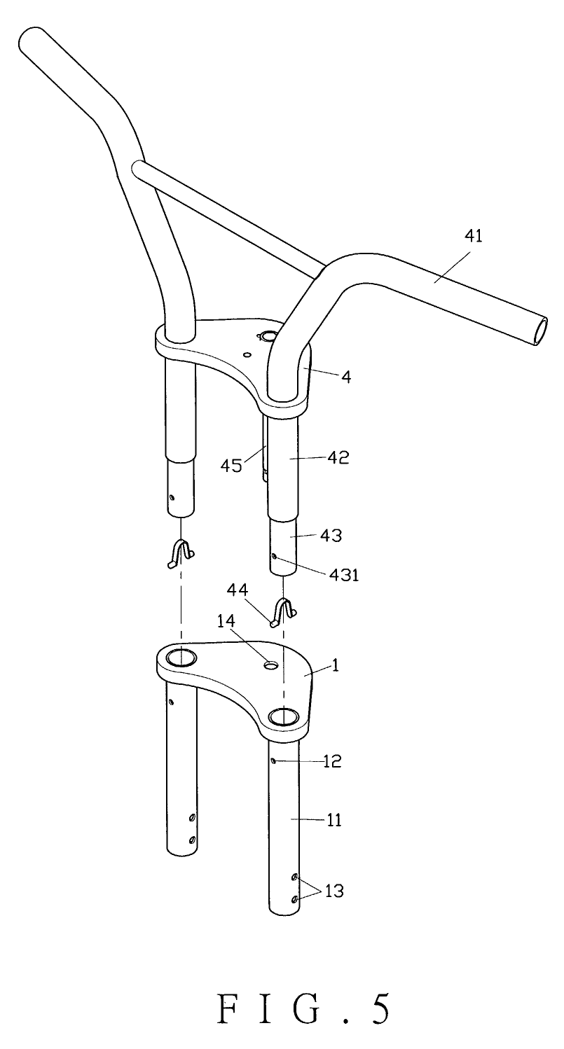

FIG. 5 shows a third embodiment of the present invention, which simplifies the production method and saves assembly time. The front strut 1 has a pair of hollow outer pipes 11. Each outer pipe 11 has a pair of holes 12 on the upper portion and a plurality of locating holes 13 at the lower portion. The front strut 1 further comprises a pivoting hole 14 at the rear portion. A handle support 4 comprises a pair of handles 41 on the top. Each handle 41 extends a hollow insertion pipe 42 downwardly with a reduced section 43 at the bottom end thereof. Each reduced section 43 comprises a pair of holes 431 adapted for an elastic clip 44 to extend from there. The rear portion of the handle support 4 comprises a connecting rod 45.

To assemble the invention, the wheel A is placed between the two outer pipe 11 of the front struts 1 and secured to the locating holes 13 by means of fasteners D. The connecting rod 45 is inserted through the pivoting hole 14 of the front strut 1 and into the connecting pipe C, whereas the reduced sections 43 of the insertion rods 42 of the handle support 4 are inserted into the outer pipes 11, this insertion allows the clips 44 to extend from the holes 431 of the reduced sections 43 into the holes 12 of the outer pipe 11, whereas the connecting rod 45 is also inserted into the pivoting hole 14 of the front strut 1 and secured by a fastener E. This completes the assembling procedure.

I claim:

1. A children's tricycle front strut structure comprising a front strut, a handle support and a handle, wherein said front strut comprising a pivoting hole, said handle support comprising a pivoting rod, and said handle being secured to said handle support, and being characterized in that:
said front strut comprising a pair of hollow outer pipes with holes, said handle support comprising a pair of insertion rods, said insertion rods of said handle support comprising holes with fasteners inside said insertion rods and extending outwardly from there.

2. The children's tricycle front strut structure, as recited in claim 1, wherein said outer pipes of said front strut comprises a plurality of locating holes at lower end thereof.

3. The children's tricycle front strut structure, as recited in claim 1, wherein each of said insertion rods comprises a reduced section at lower end thereof with holes thereat.

4. The children's tricycle front strut structure, as recited in claim 1, wherein said fasteners are elastic clips, bolts, screws, pins or rivets.

5. The children's tricycle front strut structure, as recited in claim 1, wherein said handle support comprises a C-shaped clip on top portion thereof to secure said handle with a fastener.

6. The children's tricycle front strut structure, as recited in claim 1, wherein said handle fixed on said handle support comprises insertion rods extending downwardly for insertion into said outer pipes of said front strut.
